(19) United States
(12) Patent Application Publication
(10) Pub. No.: US 2025/0105709 A1
(43) Pub. Date: Mar. 27, 2025

(54) TECHNIQUES FOR ISOLATING ELECTRICAL CURRENT FROM A MOTOR IN AN ELECTRIC POWER STEERING SYSTEM

(71) Applicant: BRP MEGATECH INDUSTRIES INC., Valcourt (CA)

(72) Inventors: Emmanuel RACINE, Shawinigan (CA); Jean-Francois VEILLETTE, St. Boniface (CA)

(21) Appl. No.: 18/832,694

(22) PCT Filed: Jan. 28, 2022
(86) PCT No.: PCT/IB2022/050778

§ 371 Date: Jul. 24, 2024

(51) Int. Cl. H02K 11/33; B62D 5/04; H02K 11/00

(52) U.S. Cl. CPC H02K 11/33; B62D 5/0475; B62D 5/0487; H02K 11/0094; H02K 2213/06

(57) ABSTRACT

An electric power steering system is provided. The electric power steering system includes an electric motor (12), a battery (14) configured to provide power, and a motor drive circuit (18) configured to provide power from the battery (14) to the motor (12). The motor drive circuit (18) includes a set of branches (28a, 28b 28c), each including two transistors (30a, 30b; 30c 30d; 30e, 30f) configured to operate in a conducting or non-conducting state. The electric power steering system includes a phase isolation circuit (20) including a set of phase isolation branches (32a, 32b, 32c), the branches (32a, 32b, 32c) being coupled to the phase windings (26a, 26b, 26c) of the electric motor (12). A phase isolation branch (32a, 32b, 32c) includes a bidirectional TVS diode (36a, 36b, 36c) and a phase isolation transistor (34a, 34b, 34c), the phase isolation transistor (34a, 34b, 34c) being configured to operate in a conducting or non-conducting state. The electric power steering system includes a fault detector configured to detect a fault condition and switch the phase isolation transistors (34a, 34b, 34c) to the non-conducting state in response to detecting the fault condition.

### BACKGROUND

### 1. Field of the Invention

The subject invention relates to systems, methods, and apparatuses relating to electric power steering, and more specifically, systems, methods, and apparatuses for isolating electric current from an electric power steering motor.

### 2. Description of Related Art

Conventionally, electric power steering systems facilitate the steering of a motor vehicle by augmenting a driver's steering effort through the use of electrical power. These electric power steering systems typically involve a variety of sensors, a controller, and an electric motor. In a general configuration, the driver of the motor vehicle requests an amount of torque from the electric power steering system using a steering wheel or handlebar. The variety of sensors receive and relay the requested torque to the controller for further analysis. The controller then takes the requested torque value and uses it to determine the correct amount of electrical current to provide to the electric motor. In this way, the electric motor is able to properly facilitate the steering of the motor vehicle

However, there remains a need in the art to instantly isolate electrical current from the motor when a fault is detected in the electric power steering system. As such, there are opportunities to address at least the aforementioned problem.

### SUMMARY

One implementation of an electric power steering system is provided. The electric power steering system comprises an electric motor comprising a phase winding; a battery configured to provide power; a motor drive circuit coupled to the battery and to the electric motor, the motor drive circuit being configured to provide power from the battery to the motor, the motor drive circuit comprising a branch including a transistor configured to operate in a conducting state and a non-conducting state, the branch being coupled to the phase winding of the electric motor; a phase isolation circuit comprising a phase isolation branch coupled to the branch of the motor drive circuit and to the phase winding, such that the branch is coupled to the phase winding of the electric motor via the phase isolation branch, wherein the phase isolation branch includes: a bidirectional transient voltage suppressor (TVS) diode coupled to the phase winding of the electric motor; and a phase isolation transistor configured to operate in a conducting state and a non-conducting state, the phase isolation transistor being coupled to the phase winding of the electric motor; and a fault detector configured to detect a fault condition and switch the phase isolation transistor to the non-conducting state in response to detecting the fault condition.

One implementation of a method of isolating power from an electric motor of an electric power steering system is provided. The electric power steering system includes a battery, a phase isolation circuit including a phase isolation transistor and a bidirectional transient voltage suppressor (TVS) diode, a motor drive circuit coupled to the battery and coupled to the electric motor via the phase isolation circuit and including a transistor. The method comprises steps of: controlling the transistor of the motor drive circuit to provide power from a battery to the electric motor via a phase isolation circuit; detecting a fault condition of the electric power steering system; controlling the phase isolation transistor of the phase isolation circuit to prevent the motor drive circuit from providing power to the electric motor; and diverting current induced by the motor, with the TVS diode, from the phase isolation transistor after controlling the transistor of the phase isolation circuit to prevent the motor drive circuit from providing power to the electric motor.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of an electric power steering system.

FIG. 2 is a schematic view of a controller, a motor drive circuit, a phase isolation circuit, and a motor of the electric power steering system of FIG. 1.

FIG. 3 is a circuit diagram of the motor drive circuit, the phase isolation circuit, and the motor of FIG. 2.

FIG. 4 is a flowchart illustrating a configuration of a fault detector of the electric power steering system of FIG. 1.

FIG. 5 is a circuit diagram of the motor drive circuit, the phase isolation circuit, and the motor of FIG. 2, wherein the motor induces a current.

FIG. 6 is a circuit diagram of the motor drive circuit, the phase isolation circuit, and the motor of FIG. 2, wherein a short circuit fault condition exists across a transistor of the motor drive circuit.

FIG. 7 is a circuit diagram of the motor drive circuit, the phase isolation circuit, and the motor of FIG. 2, wherein a short circuit fault condition exists across a TVS diode of the phase isolation circuit.

### DETAILED DESCRIPTION

Referring to the Figures, wherein like numerals indicate like or corresponding parts throughout the several views, an electric power steering unit for isolating electrical current from a motor is provided.

### I. Electric Power Steering System Overview

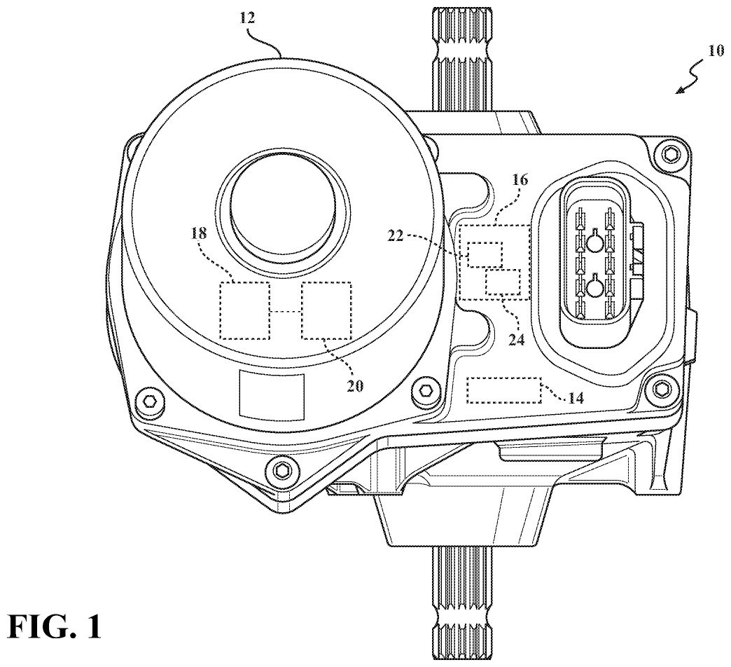

An instance of the electric power steering system 10 is shown in FIG. 1. The electric power steering system 10 shown in FIG. 1 includes an electric motor 12, a battery 14, a motor drive circuit 18, and a phase isolation circuit 20.

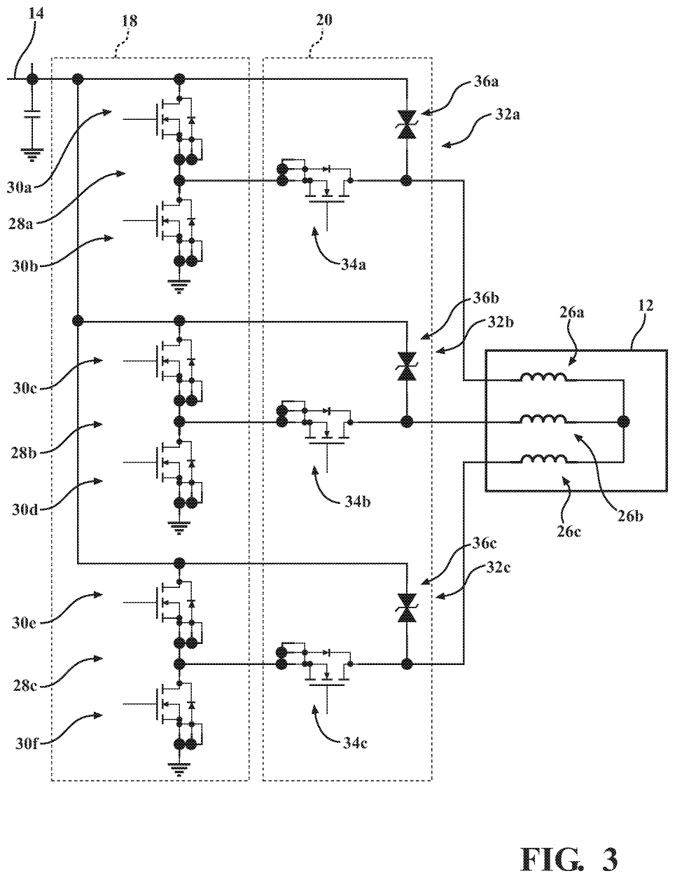

The motor 12 may be any motor suitable for an electric power steering system 10. In the instance of FIG. 3, the motor 12 is a three-phase induction motor with a first-, second-, and third-phase winding 26a, 26b, 26c. In other instances, the motor 12 may be a single-phase induction motor including a single-phase winding, or a dual-phase induction motor including two phase windings. Additionally, it is contemplated that the motor 12 may be a DC motor.

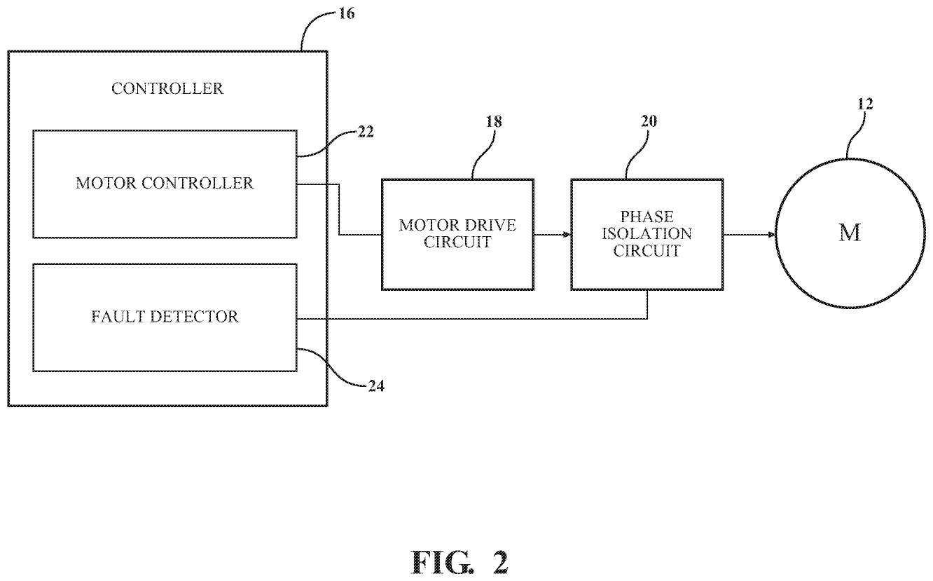

The battery is configured to provide power to the motor drive circuit 18 and the motor drive circuit 18 is configured to provide power from the battery 14 to the motor 12. The phase isolation circuit 20 is configured to isolate the motor drive circuit 18 from the motor 12 in response to detected faults of the motor drive circuit 18 and/or the phase isolation circuit 20. As shown in FIG. 2, the motor drive circuit 18 is coupled to the electric motor 12 via the phase isolation circuit 20. In this way, the phase isolation circuit 20 is configured to isolate the motor drive circuit 18 from the motor 12 by preventing the motor drive circuit 18 from providing power to the motor 12.

Also shown in FIG. 1, the electric power steering system 10 may include a controller 16. The controller 16 is configured to control components (to be described in greater detail herein) of the motor drive circuit 18 and the phase isolation circuit 20. Specifically, the motor drive circuit 18 includes a motor controller 22 configured to control components of the motor drive circuit 18 and a fault detector 24 configured to control components of the phase isolation circuit 20. FIG. 2 illustrates a relationship between the motor controller 22, the fault detector 24, the motor drive circuit 18, and the phase isolation circuit 20.

### II. Construction of the Motor Drive Circuit

The motor drive circuit 18 is further shown in FIG. 3. As shown, the motor drive circuit 18 includes a first, second, and third branch 28a, 28b, 28c, each branch being coupled to a phase winding 26a, 26b, 26c of the motor 12. In this way, the motor drive circuit 18 provides power to a phase winding 26a, 26b, 26c via a branch 28a, 28b, 28c.

Each branch 28a, 28b, 28c includes a first and second transistor 30a, 30b, 30c, 30d, 30e, 30f such that the motor drive circuit 18 includes a total of six transistors. Each of the transistors 30a, 30b, 30c, 30d, 30e, 30f may be configured to operate in a conducting state and a non-conducting state.

The transistors 30a, 30b, 30c, 30d, 30e, 30f may be any suitable power transistor. For example, the transistors 30a, 30b, 30c, 30d, 30e, 30f may be a bipolar junction transistor (BJT) or a field-effect transistor (FET). More specifically, the transistors 30a, 30b, 30c, 30d, 30e, 30f may be a PNP transistor, a NPN transistor, a junction-gate field-effect transistor (JFET), an n-type metal-oxide semiconductor field-effect transistor (N-MOSFET), a p-type metal-oxide-semiconductor field-effect transistor (P-MOSFET), or any other suitable transistor. In the example configuration of FIG. 3, the transistors 30a, 30b, 30c, 30d, 30e, 30f are illustrated as N-MOSFETs.

It should be noted that the motor drive circuit 18 includes three branches 28a, 28b, 28c such that the motor drive circuit 18 may provide power from the battery 14 to each phase winding 26a, 26b, 26c of the motor. It is contemplated that, in instances where the motor 12 is a single-phase induction motor or a dual-phase induction motor, the motor drive circuit 18 may include a single branch or two branches, respectively. As follows, in instances where the motor 12 is a single-phase induction motor or a dual-phase induction motor, the motor drive circuit 18 may include a total of two transistors or four transistors, respectively.

It should also be noted that the motor drive circuit 18 may include any suitable number of transistors. It is contemplated that each branch 28a, 28b, 28c may have a different number of transistors. It is also contemplated that each phase isolation branch 32a, 32b, 32c may include less than two transistors. It is further contemplated that each phase isolation branch 32a, 32b, 32c may include more than two transistors.

### III. Configuration of the Motor Controller

The motor controller 22 is configured to switch the transistors 30a, 30b, 30c, 30d, 30e, 30f between a conducting state and a non-conducting state. In this way, the motor controller 22 is configured to control the motor drive circuit 18 to provide power from the battery 14 to the motor 12. For example, the motor controller 22 may control the first and second transistor 30a, 30b of the first branch 28a such that the motor controller 22 controls the motor drive circuit 18 to provide power via the first branch 28a. Specifically, the motor controller 22 may control the first and/or second transistor 30a, 30b to be in the conducting state such that the motor drive circuit 18 provides power via the first branch 28a. The motor controller 22 may control the first and second transistors 30a, 30b to be in the non-conducting state such that the motor drive circuit 18 does not power via the first branch 28a.

The motor controller 22 may control the motor drive circuit 18 based on a variety of inputs. For example, the motor controller 22 may control the motor drive circuit 18 based on the detection of a fault condition (to be described in greater detail below). As another example, the motor controller 22 may control the motor drive circuit 18 based on an input from a user of the electric power steering system 10 and/or systems coupled to the electric power steering system 10. For instance, the motor controller 22 may control the motor drive circuit 18 based on an input received by a steering wheel coupled to the electric power steering system 10.

### IV. Construction of the Phase Isolation Circuit

The phase isolation circuit 20 is further shown in FIG. 3. As shown, the phase isolation circuit 20 includes a first, second, and third phase isolation branch 32a, 32b, 32c coupled to a corresponding branch 28a, 28b, 28c of the motor drive circuit 18 and to a corresponding phase winding 26a, 26b, 26c of the motor 12. As previously stated, and as further shown in FIG. 3, the motor drive circuit 18 is coupled to the motor 12 via the phase isolation circuit 20. Specifically, each branch 28a, 28b, 28c of the motor drive circuit 18 is coupled to the motor 12 via the corresponding phase isolation branch 32a, 32b, 32c, the branches 28a, 28b, 28c being coupled to the phase isolation circuit 20 in parallel with one another.

Each phase isolation branch 32a, 32b, 32c includes a phase isolation transistor 34a, 34b, 34c such that the phase isolation circuit 20 includes a total of three transistors. Each of the phase isolation transistors 34a, 34b, 34c may be configured to operate in a conducting state and a non-conducting state.

The phase isolation transistor 34a, 34b, 34c may be any suitable transistor. For example, the phase isolation transistor 34a, 34b, 34c may be a bipolar junction transistor (BJT) or a field-effect transistor (FET). More specifically, the phase isolation transistor 34a, 34b, 34c may be a PNP transistor, a NPN transistor, a junction-gate field-effect transistor (JFET), a metal-oxide-semiconductor field-effect transistor (MOSFET), or any other suitable transistor. In the example configuration of FIG. 3, the phase isolation transistors 34a, 34b, 34c are shown as MOSFETs.

Each phase isolation branch 32a, 32b, 32c also includes a diode 36a, 36b, 36c such that the phase isolation circuit 20 includes a total of three diodes 36a, 36b, 36c. As shown in FIG. 3, the diodes 36a, 36b, 36c of phase isolation branch 32a, 32b, 32c and each corresponding phase isolation transistor 34a, 34b, 34c are coupled to a phase winding 26a, 26b, 26c of the motor 12.

In the example configuration shown in FIG. 3, the diodes 36a, 36b, 36c are illustrated as bidirectional TVS diodes. However, it is contemplated that the diodes 36a, 36b, 36c may be any set of suitable diodes performing a suppression function. For example, the diodes 36a, 36b, 36c may include one or more of a Schottky diode, a junction diode, a Zener diode, and a unidirectional TVS diode. Furthermore, the diodes 36a, 36b, 36c may be selected to ensure proper operation. For example, the diodes 36a, 36b, 36c may be selected based on a threshold voltage, a reverse working voltage, a maximum forward current, a junction operating temperature, and/or any other diode specification.

It should be noted that the phase isolation circuit 20 includes three phase isolation branches 32a, 32b, 32c such that the phase isolation circuit 20 may provide power from the motor drive circuit 18 to each phase winding 26a, 26b, 26c of the motor. It is contemplated that, in instances where the motor 12 is a single-phase induction motor or a dual-phase induction motor, the phase isolation circuit 20 may include a single phase isolation branch or two phase isolation branches, respectively. In instances where the motor 12 is a single-phase induction motor or a dual-phase induction motor, the phase isolation circuit 20 may include a single phase isolation transistor or two phase isolation transistors, respectively. Furthermore, in instances where the motor 12 is a single-phase induction motor or a dual-phase induction motor, the phase isolation circuit 20 may include a single diode or two diodes, respectively.

It should also be noted that the phase isolation circuit 20 may include any suitable number of phase isolation transistors and diodes. It is contemplated that each phase isolation branch 32a, 32b, 32c may have a different number of transistors and diodes. It is also contemplated that each phase isolation branch 32a, 32b, 32c may have more than one transistor and more than one diode.

### V. Configuration of the Fault Detector

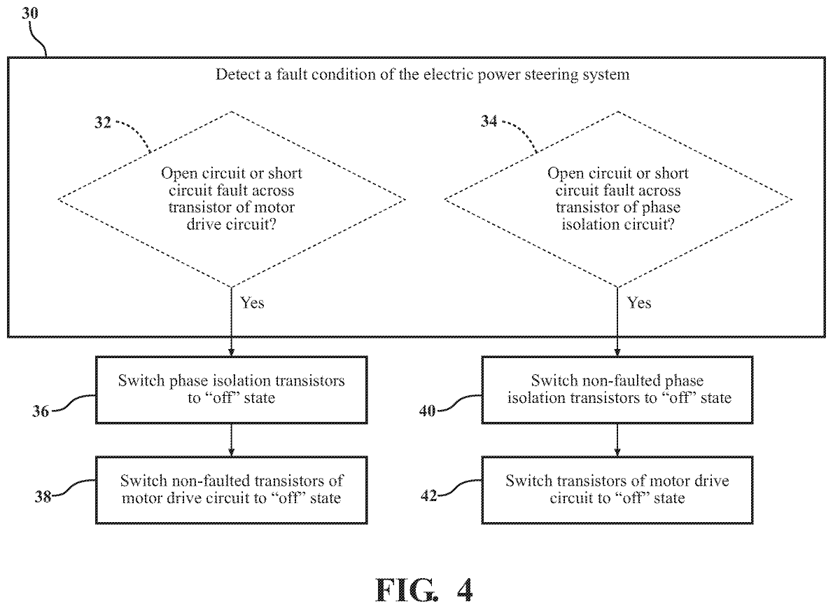

FIG. 4 illustrates an example configuration of the fault detector 24. As shown, the fault detector 24 may be configured to detect a fault condition of the electric power steering system 10 during step 30. Specifically, the fault detector 24 is configured to detect an open circuit fault and/or a short circuit fault across a transistor 30a, 30b, 30c, 30d, 30e, 30f of the motor drive circuit 18 during step 32 and to detect an open circuit fault and/or a short circuit fault across a transistor 34a, 34b, 34c of the phase isolation circuit 20 during step 34.

During an open circuit or short circuit fault, a transistor 30a, 30b, 30c, 30d, 30e, 30f, 34a, 34b or 34c has malfunctioned and operates in an unintended manner. For example, an open circuit fault across a transistor 30a, 30b, 30c, 30d, 30e, 30f, 34a, 34b or 34c causes the transistor to function as an open circuit when the transistor should operate in the conducting state. A short circuit fault across a transistor 30a, 30b, 30c, 30d, 30e, 30f, 34a, 34b or 34c causes the transistor to function as a short circuit when the transistor should function in the non-conducting state.

The fault detector 24 may be configured to detect a fault condition of the electric power steering system 10 using a variety of methods. In some instances, the fault detector 24 may compare an expected operation of the electric power steering system 10 with an actual operation of the electric power steering system 10 to determine whether a fault condition has occurred. Specifically, the fault detector 24 may determine and compare an amount of voltage and current provided to each winding 26a, 26b, 26c to an expected amount of voltage and current to be provided to each winding 26a, 26b, 26c.

Furthermore, it should be noted that the fault detector 24 may detect more than one fault condition. For example, the fault detector 24 may detect an open circuit fault and/or a short circuit fault across more than one transistor 30a, 30b, 30c, 30d, 30e, 30f of the motor drive circuit 18; the fault detector 24 may detect an open circuit fault and/or a short circuit fault across a transistor 30a, 30b, 30c, 30d, 30e or 30f of the motor drive circuit 18 and a phase isolation transistor 34a, 34b or 34c of the phase isolation circuit 20; and the fault detector 24 may detect an open circuit fault and/or a short circuit fault across more than one phase isolation transistor 34a, 34b, 34c of the phase isolation circuit 20.

Referring back to FIG. 4, if the fault detector 24 detects an open circuit fault and/or a short circuit fault across a transistor 30a, 30b, 30c, 30d, 30e or 30f of the motor drive circuit 18 during step 32, the fault detector 24 switches the phase isolation transistors 34a, 34b, 34c to the non-conducting state during step 36. For example, if the fault detector 24 detects an open circuit fault across the transistor 30a, the fault detector 24 switches the phase isolation transistors 34a, 34b, 34c to the non-conducting state. In this way, the fault detector 24 detects whether the motor drive circuit 18 is correctly providing power to the motor 12 by detecting the existence of a fault condition in the motor drive circuit 18. Accordingly, by switching the phase isolation transistors 34a, 34b, 34c to the non-conducting state, fault detector 24 prevents the motor drive circuit 18 from providing power to the motor 12, isolating the motor drive circuit 18 from the motor 12 and preventing self-induced current from circulating in the motor.

Additionally, if the fault detector 24 detects an open circuit fault and/or a short circuit fault across a transistor 30a, 30b, 30c, 30d, 30e or 30f of the motor drive circuit 18 during step 32, the fault detector 24 may switch the non-faulted transistors 30a, 30b, 30c, 30d, 30e, 30f to the non-conducting state during step 38. For example, in an instance where the fault detector 24 detects a short circuit fault across the transistor 30a, the fault detector 24 switches the non-faulted transistors 30b, 30c, 30d, 30e, 30f to the non-conducting state. As another example, in an instance where the fault detector 24 detects an open circuit fault across the transistors 30a, 30b, 30e, the fault detector 24 switches the non-faulted transistors 30c, 30d, 30f to the non-conducting state. In this way, the motor drive circuit 18 is further prevented from providing power to the motor 12 and is isolated from the motor 12. Self-induced currents in the motor are also prevented.

Also shown in FIG. 4, if the fault detector 24 detects an open circuit fault and/or a short circuit fault across a phase isolation transistor 34a, 34b or 34c of the phase isolation circuit 20 during step 34, the fault detector 24 switches the non-faulted phase isolation transistors 34a, 34b, 34c to the non-conducting state during step 40. For example, if the fault detector 24 detects an open circuit fault across the phase isolation transistor 34a, the fault detector 24 switches the phase isolation transistors 34b, 34c to the non-conducting state. As another example, if the fault detector 24 detects a short circuit fault across the phase isolation transistors 34a or 34b, the fault detector 24 switches the phase isolation transistor 34c to the non-conducting state.

Additionally, if the fault detector 24 detects an open circuit fault and/or a short circuit fault across a phase isolation transistor 34a, 34b or 34c of the phase isolation circuit 20 during step 42, the fault detector 24 may switch the transistors 30a, 30b, 30c, 30d, 30e, 30f to the non-conducting state. For example, in an instance where the fault detector 24 detects a short circuit fault across the phase isolation transistor 34a, the fault detector 24 switches the transistors 30a, 30b, 30c, 30d, 30e, 30f to the non-conducting state.

### VI. Configuration of the Diodes

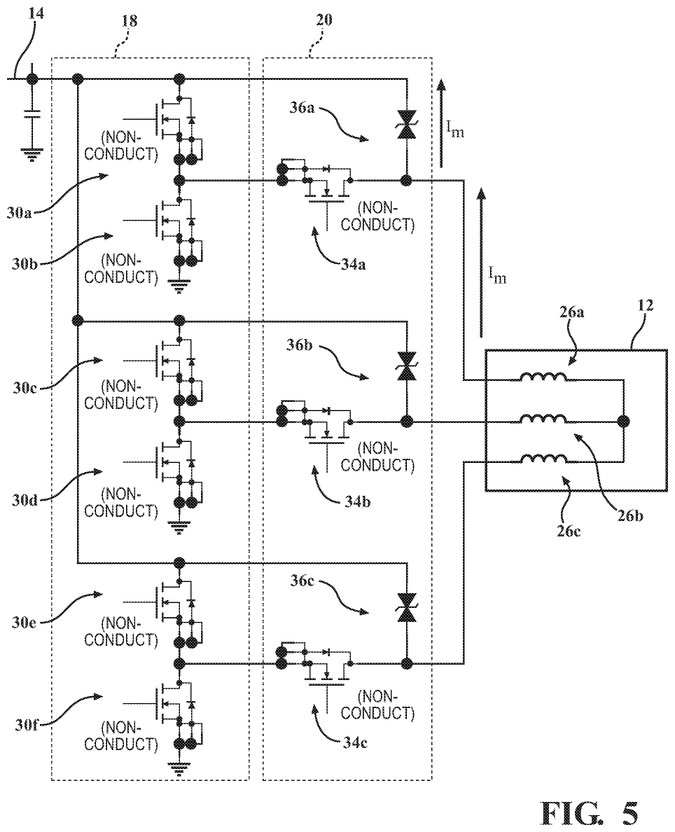

In some instances, the motor 12 may induce an electrical current after the fault detector 24 controls the phase isolation circuit 20 to isolate the motor drive circuit 18 from the motor 12. Such current arises because, after the phase isolation circuit 20 isolates the motor drive circuit 18 from the motor 12, the motor drive circuit 18 is no longer providing power to the motor 12. However, immediately after the phase isolation circuit 20 isolates the motor drive circuit 18 from the motor 12, the motor 12 is still rotating and/or its windings energized, inducing a current. The induced current Iₘ is shown in FIG. 5 in branch 28a but could also be in branch 28b or 28c.

Also shown in FIG. 5, the induced current Iₘ flows through the diode 36a after the fault detector 24 switches the phase isolation transistors 34a, 34b, 34c to the non-conducting state. In this way, the induced current Iₘ flows through the diode 36a, diverting the induced current Iₘ from the phase isolation transistors 34a, 34b, 34c. In this way, the induced current Iₘ is dissipated through the diode 36a and does not flow through the phase isolation transistors 34a, 34b, 34c.

Diverting the induced current Iₘ from the phase isolation transistors 34a, 34b, 34c offers several advantages.

Firstly, the diodes 36a, 36b, 36c allow the motor drive circuit 18 to be isolated from the motor 12, despite the presence of the induced current Iₘ. Should the diodes 36a, 36b, 36c be removed from the phase isolation circuit 20, the induced current Iₘ would flow through the phase isolation transistors 34a, 34b, 34c. In some instances, the induced current Iₘ may switch the phase isolation transistors 34a, 34b, 34c and, thereafter, the transistors 30a, 30b, 30c, 30d, 30e, 30f to a conducting state. As a result, the motor drive circuit 18 would not be isolated from the motor 12.

Secondly, the diodes 36a, 36b, 36c protect the phase isolation transistors 34a, 34b, 34c and the transistors 30a, 30b, 30c, 30d, 30e, 30f from damage. As previously stated, should the diodes 36a, 36b, 36c be removed from the phase isolation circuit 20, the induced current Iₘ would flow through the phase isolation transistors 34a, 34b, 34c. In instances where the induced current Iₘ is particularly large, the phase isolation transistors 34a, 34b, 34c and the transistors 30a, 30b, 30c, 30d, 30e, 30f may be damaged.

Thirdly, the presence of diodes 36a, 36b, 36c allow the fault detector 24 to rapidly switch the phase isolation transistors 34a, 34b, 34c to the non-conducting state. Specifically, the fault detector 24 detects a fault condition at a first time and is configured to switch a corresponding phase isolation transistors 34a, 34b, 34c to the non-conducting state at a second time. A time delay is defined as a difference between the second time and the first time. Here, the time delay is less than a predefined safety-critical time delay based on the application. For example, in instances where the fault detector 24 detects an open circuit fault and/or a short circuit fault across a transistor 30a, 30b, 30c, 30d, 30e or 30f, the predefined safety-critical time delay may be 10 μs, 50 μs, 100 μs, or 500 μs. In instances where the fault detector 24 detects an open circuit fault and/or a short circuit fault across a phase isolation transistor 34a, 34b or 34c, the predefined safety-critical time delay may be 10 ms, 50 ms, 100 ms, or 500 ms.

In contrast, should the diodes 36a, 36b, 36c be removed from the phase isolation circuit 20, a time delay greater than the predetermined time delay is required prior to switching the phase isolation transistors 34a, 34b, 34c to the non-conducting state. This is because, in order to prevent the induced current Iₘ from flowing through the phase isolation transistors 34a, 34b, 34c, a time delay greater than the predetermined time delay is required to allow the induced current Iₘ to naturally decay. Otherwise, if the phase isolation transistors 34a, 34b, 34c are too quickly switched to the non-conducting state and the phase isolation circuit 20 does not include diodes 36a, 36b, 36c to dissipate the induced current Iₘ, the induced current Iₘ will flow through the phase isolation transistors 34a, 34b, 34c and, thereafter, to the transistors 30a, 30b, 30c, 30d, 30e, 30f.

Fourthly, the presence of diodes 36a, 36b, 36c diverts the induced current Iₘ from the phase isolation transistors 34a, 34b, 34c, regardless of the fault condition detected by the fault detector 24. Specifically, regardless of whether the fault detector 24 detects an open circuit fault and/or a short circuit fault across the transistors 30a, 30b, 30c, 30d, 30e, 30f and regardless of whether the fault detector 24 detects an open circuit fault and/or a short circuit fault across the phase isolation transistors 34a, 34b, 34c, the diodes 36a, 36b, 36c divert the induced current Iₘ from the phase isolation transistors 34a, 34b, 34c.

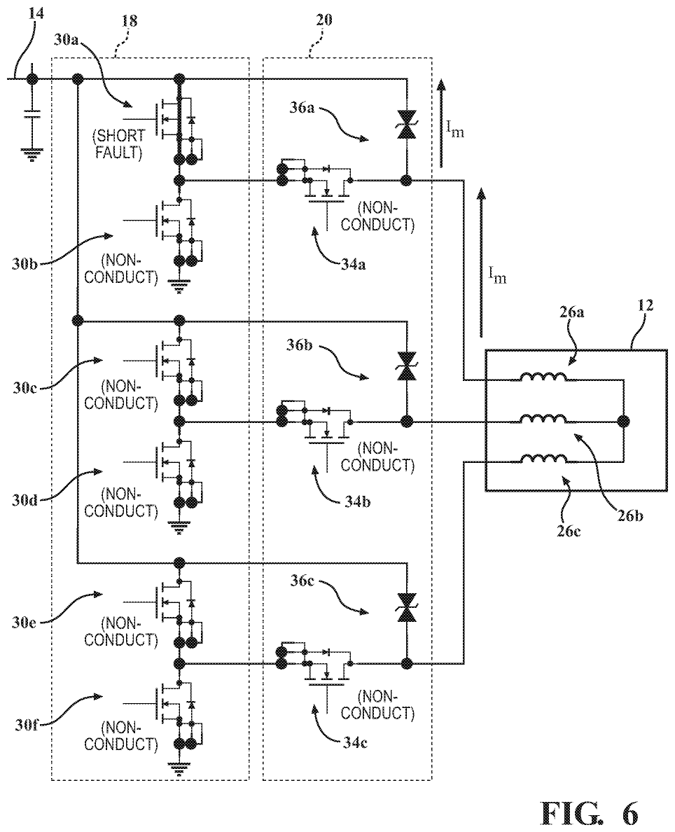

Referring to FIG. 6, an example is provided where a short circuit fault exists across the transistor 30a. As shown, when phase isolation transistors 34a, 34b, 34c are switched to the non-conducting state upon detection of the fault, the induced current Iₘ flows through the diode 36a, instead of through the phase isolation transistor 34a, which is in the non-conducting state. The current flow will last for as long as the induced voltage by the motor is at least greater than the blocking voltage of diode 36a and will then stop.

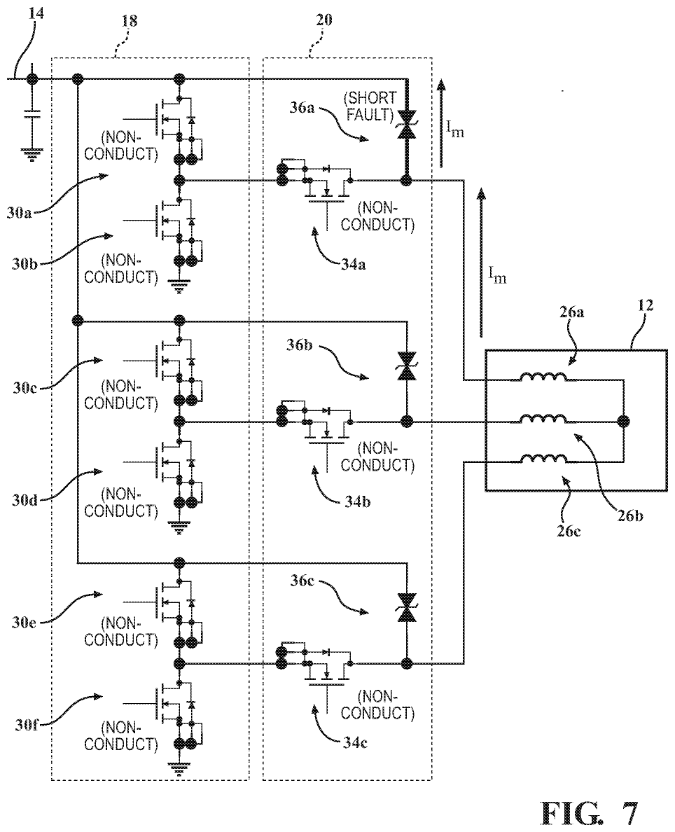

Fifthly, if diodes 36a, 36b, 36c themselves encounter a short circuit fault condition, such as shown in FIG. 7, the induced current Iₘ will only be able to flow in the circuit if the induced voltage by the motor is greater than the battery voltage or the blocking voltage of diodes 36a, 36b, 36c. The induced current Iₘ will be zero, otherwise.

While the diodes 36a, 36b, 36c may be any set of suitable diodes, there are certain advantages to using bidirectional TVS diodes. Specifically, the TVS diodes 36a, 36b, 36c are able to protect against transient voltages from the battery 14. This is because the TVS diodes 36a, 36b, 36c will start conducting current if their threshold voltage is exceeded, therefore clipping the transient voltages.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

1. An electric power steering system comprising:
an electric motor comprising a phase winding;
a battery configured to provide power;
a motor drive circuit coupled to the battery and to the electric motor, the motor drive circuit being configured to provide power from the battery to the electric motor, the motor drive circuit comprising a branch including a transistor configured to operate in a conducting state and a non-conducting state, the branch being coupled to the phase winding of the electric motor;
a phase isolation circuit comprising a phase isolation branch coupled to the branch of the motor drive circuit and to the phase winding, such that the branch is coupled to the phase winding of the electric motor via the phase isolation branch, wherein the phase isolation branch includes;
a bidirectional transient voltage suppressor (TVS) diode coupled to the phase winding of the electric motor; and
a phase isolation transistor configured to operate in a conducting state and a non-conducting state, the phase isolation transistor being coupled to the phase winding of the electric motor; and
a fault detector configured to detect a fault condition and switch the phase isolation transistor to the non-conducting state in response to detecting the fault condition;
wherein the bidirectional TVS diode is configured for allowing a current to flow bidirectionally therethrough when a voltage across the bidirectional TVS diode exceeds a blocking voltage of the bidirectional TVS diode.

2. The electric power steering system of claim 1, wherein the phase winding is further defined as a first phase winding, and wherein the electric motor further comprises a second phase winding and a third phase winding:

3. The electric power steering system of claim 2, wherein the branch is further defined as a first branch, and wherein the motor drive circuit further comprises:
a second branch including a second transistor, the second branch being coupled to the second phase winding of the electric motor; and
a third branch including a third transistor, the third branch being coupled to the third phase winding of the electric motor.

4. The electric power steering system of claim 3, wherein the first branch, the second branch, and the third branch are coupled to the phase isolation circuit in parallel with one another.

5. The electric power steering system of claim 3, wherein the phase isolation branch is further defined as a first phase isolation branch, wherein the bidirectional TVS diode is further defined as a first bidirectional TVS diode, and wherein the phase isolation transistor is further defined as a first phase isolation transistor, and wherein the phase isolation circuit further comprises:
a second phase isolation branch coupled to the second branch of the motor drive circuit and to the second phase winding, the second branch being coupled to the second phase winding of the electric motor via the second phase isolation branch, the second phase isolation branch including a second bidirectional TVS diode and a second phase isolation transistor, the second bidirectional TVS diode and the second phase isolation transistor being coupled to the second phase winding of the electric motor; and
a third phase isolation branch coupled to the third branch of the motor drive circuit and to the third phase winding, the third branch being coupled to the third phase winding of the electric motor via the third phase isolation branch, the third phase isolation branch including a third bidirectional TVS diode and a third phase isolation transistor, the third bidirectional TVS diode and the third phase isolation transistor being coupled to the third phase winding of the electric motor.

6. The electric power steering system of claim 1, further comprising a motor controller configured to switch the transistor between a conducting state and a non-conducting state.

7. The electric power steering system of claim 1, wherein a current induced by the electric motor flows through the bidirectional TVS diode after the fault detector switches the phase isolation transistor to the non-conducting state.

8. The electric power steering system of claim 1, wherein the bidirectional TVS diode is configured to divert a current induced by the electric motor from the phase isolation transistor after the fault detector switches the phase isolation transistor to the non-conducting state.

9. The electric power steering system of claim I, wherein the fault detector detects a fault condition at a first time, wherein the fault detector is configured to switch the phase isolation transistor to the non-conducting state at a second time, and wherein a difference between the second time and the first time is less than a predetermined time delay.

10. The electric power steering system of claim 9, wherein the predetermined time delay is defined for a fault condition of the transistor and is at least one of 10 μs, 50 μs, 100 μs, or 500 μs.

11. The electric power steering system of claim 9, wherein the predetermined time delay is defined for a fault condition of the phase isolation transistor and is at least one of 10 ms, 50 ms, 100 ms, or 500 ms.

12. The electric power steering system of claim 1, wherein the fault detector is configured to detect an open circuit fault and/or a short circuit fault across the transistor.

13. The electric power steering system of claim 12, wherein the fault detector is configured to switch the phase isolation transistor to the non-conducting state in response to detecting an open circuit fault and/or a short circuit fault across the transistor.

14. The electric power steering system of claim 1, wherein the transistor is further defined as a first transistor, wherein the branch includes a second transistor, and wherein the fault detector is configured to detect an open circuit fault and/or a short circuit fault across at least one of the first transistor and the second transistor.

15. The electric power steering system of claim 14, wherein the fault detector is configured to switch one of the first transistor and the second transistor to the non-conducting state in response to detecting an open circuit fault and/or a short circuit fault across at least one of the first transistor and the second transistor.

16. The electric power steering system of claim 5, wherein the fault detector is configured to detect an open circuit fault and/or a short circuit fault across at least one of the first phase isolation transistor, the second phase isolation transistor, and the third phase isolation transistor.

17. The electric power steering system of claim 16, wherein the fault detector is configured to switch the transistor to the non-conducting state in response to detecting an open circuit fault across at least one of the first phase isolation transistor, the second phase isolation transistor, and the third phase isolation transistor.

18. The electric power steering system of claim 16, wherein the fault detector is configured to switch one of the first phase isolation transistor, the second phase isolation transistor, and the third phase isolation transistor to the non-conducting state in response to detecting an open circuit fault across either of the other phase isolation transistors.

19. A method of isolating power from an electric motor of an electric power steering system, the electric power steering system including a battery, a phase isolation circuit including a phase isolation transistor and a bidirectional transient voltage suppressor (TVS) diode, a motor drive circuit coupled to the battery and coupled to the electric motor via the phase isolation circuit and including a transistor, the method comprising steps of:
controlling the transistors of the motor drive circuit to provide power from a battery to the electric motor via a phase isolation circuit;
detecting a fault condition of the electric power steering system;
controlling the phase isolation transistors of the phase isolation circuit to prevent the motor drive circuit from providing power to the electric motor; and
diverting a current induced by the electric motor, with the bidirectional TVS diode, from the phase isolation transistor after controlling the transistor of the phase isolation circuit to prevent the motor drive circuit from providing power to the electric motor, the bidirectional TVS diode allowing the current induced by the electric motor to flow bidirectionally therethrough, when a voltage across the bidirectional TVS diode exceeds a blocking voltage of the bidirectional TVS diode.

20. The method of claim 19, wherein the step of detecting a fault condition of the electric power steering system comprises detecting an open circuit fault and/or a short circuit fault across the transistor of the motor drive circuit.

21. The method of claim 19, wherein the step of controlling the transistor phase isolation circuit comprises a step of switching the phase isolation transistor from a conducting state to a non-conducting state.
